(19) United States
(12) Patent Application Publication
(10) Pub. No.: US 2013/0141943 A1
(43) Pub. Date: Jun. 6, 2013

(54) Slim Bezel Backlight Module of Liquid Crystal Display Device

(71) Applicants: Yajun Yu, Shenzhen (CN); Gang Yu, Shenzhen (CN)

(72) Inventors: Yajun Yu, Shenzhen (CN); Gang Yu, Shenzhen (CN)

(21) Appl. No.: 13/381,938

(22) PCT Filed: Dec. 5, 2011
(86) PCT No.: PCT/CN2011/083446

§ 371 Date: Dec. 31, 2011

(30) Foreign Application Priority Data
Dec. 1, 2011 (CN) 201110393210.8

(51) Int. Cl. F21V 8/00; G09F 13/04

(52) U.S. Cl. 362/627; 362/97.2

(57) ABSTRACT

The present invention provides a slim bezel backlight module of liquid crystal display device, which includes: a bezel, a back panel, a connection member, and a plastic frame arranged on the back panel. The bezel includes a front plate that forms a displaying opening and a side plate extending downward from an end of the front plate. The back panel includes a bottom board that is opposite to the front plate. The front plate of the bezel is recessed to form a first extruded threaded hole having internal threading. The bottom board of the back panel forms a bore corresponding to the first extruded threaded hole. The plastic frame forms a through hole corresponding to the bore. The connection member extends through the through hole and has two ends respectively mating and connecting the first extruded threaded hole of the front plate of the bezel and the bore of the bottom board of the back panel to thereby fix the bezel to the back panel. The present invention saves a great amount of space and sites on the plastic frame and the back panel and avoids removal of material in a large area of the plastic frame for not interfering with the bumps of the bezel and the bumps of the thereby guaranteeing the structural strength of the plastic frame and helping the sliming of the bezel for the backlight module.

### BACKGROUND OF THE INVENTION

1. Field of the Invention

The present invention relates to the technical field of TFT-LCD liquid crystal displaying, and in particular to a slim bezel backlight module of a liquid crystal display device.

2. The Related Arts

Due to the advantageous features of low power consumption and low radiation, liquid crystal display devices are now widely used in the current displaying equipments. With the continuous progress of the liquid crystal technology, liquid crystal display devices that are made large in size and slim in configuration are becoming the main stream of market. A liquid crystal display device generally comprises a liquid crystal panel and a backlight module. The structure of the backlight module determines, to quite an extent, the enlarging of size and the sliming of configuration for the liquid crystal display device. Consequently, bezel sliming of the backlight module is now a trend. A backlight module generally comprises a bezel, a back panel connected to and mating the bezel, a plastic frame and a light guide plate positioned on the back panel, and an optic film positioned on the light guide plate. The bezel comprises a front plate that forms a displaying opening and a side plate extending downward from one side of the front plate. The liquid crystal panel is positioned on the backlight module and corresponds to the displaying opening of the front plate. Due to bezel sliming of the backlight module, the width of the front plate of the bezel is narrowed and the thickness thinned, all these making it no longer possible for the front plate of the bezel to provide a space for accommodating a nut. Since it does not allow the nut to project beyond the surface of the bezel, it is not possible to apply screw fixing to the front plate of the bezel.

To overcome such a problem, for the known liquid crystal display device, a solution to apply screw fixing to the slim bezel backlight module of the liquid crystal display device is to press a threaded counterbore hole in the side plate of the bezel and a bolt is used to secure to the back plane. Such a fixing arrangement requires formation of a plurality of bumps on the back panel to mate the counterbore bump feature of the bezel for screwing. They occupy a great amount of space of the back panel and are thus adverse to formation of other feature on the bump sites of the back panel. Further, to avoid position interference, the plastic frame must be hollowed at the locations corresponding to the bumps of the back panel and the bezel. This greatly reduces the structural strength of the whole plastic frame.

### SUMMARY OF THE INVENTION

An objective of the present invention is to provide a slim bezel backlight module of liquid crystal display device, which saves space, shows high structural strength, and is helpful in sliming the bezel.

To achieve the objective, the present invention provides a slim bezel backlight module of liquid crystal display device, which comprises: a bezel, a back panel, a connection member, and a plastic frame arranged on the back panel. The bezel comprises a front plate that forms a displaying opening and a side plate extending downward from one end of the front plate. The back panel comprises a bottom board that is opposite to the front plate. The front plate of the bezel is recessed to form a first extruded threaded hole having internal threading. The bottom board of the back panel forms a bore corresponding to the first extruded threaded hole. The plastic frame forms a through hole corresponding to the bore. The connection member extends through the through hole and has two ends respectively mating and connecting the first extruded threaded hole of the front plate of the bezel and the bore of the bottom board of the back panel to thereby fix the bezel to the back panel.

The connection member is a bolt and the bore is a through hole. The connection member extends through the bore and the through hole to have one of the ends thereof positioned against the bottom board of the back panel and the other one of the ends in threading engagement with the first extruded threaded hole.

The bore of the bottom board of the back panel is a second extruded threaded hole formed by recessing the bottom board of the back panel and having internal threading. The connection member is a threaded bar having two ends forming external threads respectively corresponding to the first extruded threaded hole and the second extruded threaded hole, whereby the two ends of the connection member are respectively threadingly engageable with the first extruded threaded hole and the second extruded threaded hole.

The connection member has an end face forming a cruciform or straight slit.

A light guide plate is further included and arranged on the back panel and an optic film is arranged on the light guide plate.

The back panel comprises a side board extending upward from an end of the bottom board. The plastic frame is arranged between the bezel and the back panel. The side plate of the bezel is located outside the side board of the back panel.

The efficacy of the present invention is that the present invention provides a slim bezel backlight module of liquid crystal display device that securely fixes the bezel to the front plate of the back panel by forming an extruded threaded hole in an under surface of the front plate of the bezel and ensuring the flatness of the front surface of the bezel, so as to save a great amount of space and sites on the plastic frame and the back panel and avoid removal of material in a large area of the plastic frame for not interfering with the bumps of the bezel and the bumps of the thereby guaranteeing the structural strength of the plastic frame and helping the sliming of the bezel for the backlight module.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is a partial sectioned view of a slim bezel backlight module of liquid crystal display device according to a first embodiment of the present invention;

FIG. 2 is a partial sectioned view of a slim bezel backlight module of liquid crystal display device according to a second embodiment of the present invention; and

FIG. 3 is a schematic view illustrating a connection member of FIG. 2.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

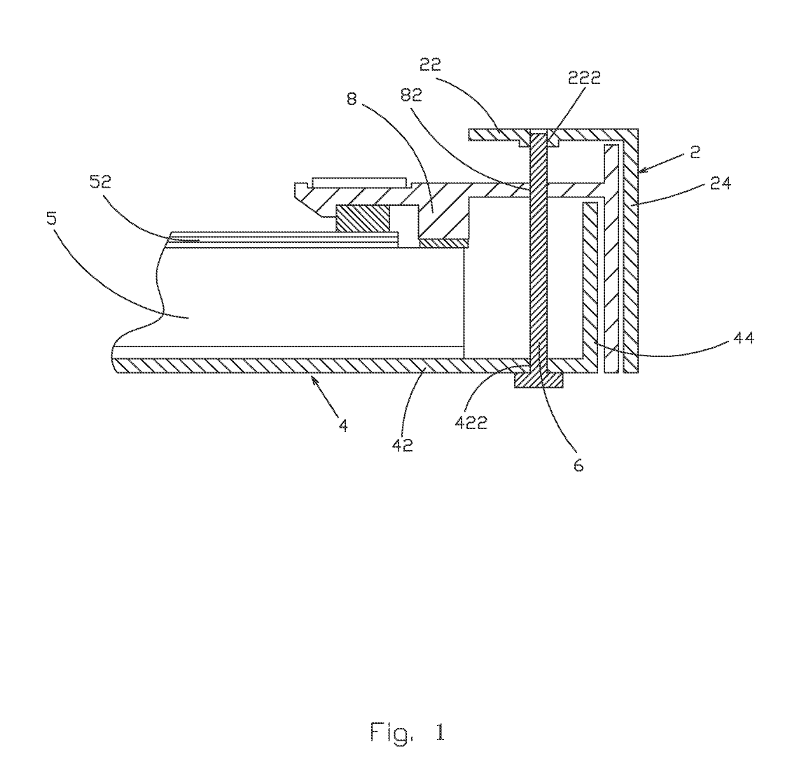

As shown in FIG. 1, a slim bezel backlight module of liquid crystal display device according to a first embodiment of the present invention is shown, which comprises: a bezel 2, a back panel 4, a light guide plate 5 arranged on the back panel 4, an optic film 52 arranged on the light guide plate 5, a connection member 6, and a plastic frame 8 arranged on the back panel 4. The connection member 6 fixes the bezel 2 to a front plate of the back panel 4.

The bezel 2 comprises a front plate 22 that forms a displaying opening and a side plate 24 extending downward from an end of the front plate. The front plate 22 is recessed to form a first extruded threaded hole 222 having internal threading, which is formed by flanging and tapping the front plate 22. The first extruded threaded hole 222 fixes the connection member 6.

The back panel 4 comprises a bottom board 42 opposite to the front plate and a side board 44 extending upward from an end of the bottom board 42. The plastic frame 8 is mounted between the bezel 2 and the back panel 4. The bezel side plate 24 is arranged outside the back panel side board 44. The bottom board 42 forms a bore 422 corresponding to the first extruded threaded hole 222 formed in the front plate 22 of the bezel 2. The plastic frame 8 forms a through hole 822 corresponding to the bore 422 formed in the bottom board 42 of the back panel 4.

In the instant embodiment, the connection member 6 is a threaded bolt, and the bore 422 is a through hole. The connection member 6 extends through the bore 422 and the through hole 822 with an end abutting the back panel bottom board 42 and an opposite end in threading engagement with the first extruded threaded hole 222 to thereby fix the bezel 2 and the back panel 4 together.

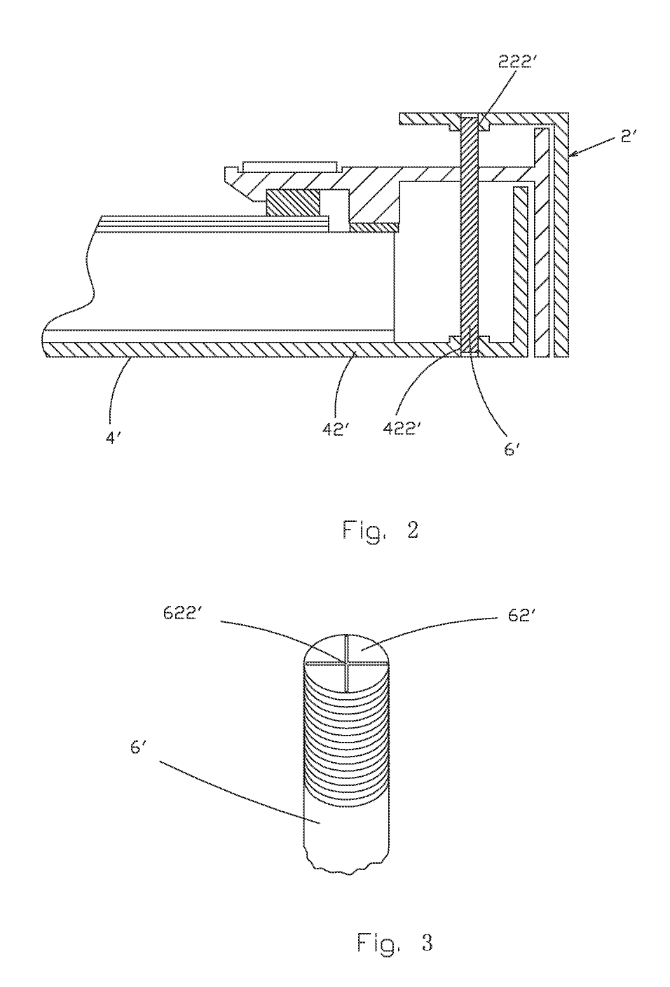

As shown in FIGS. 2-3, a slim bezel backlight module of liquid crystal display device according to a second embodiment of the present invention is shown, which is different from the first embodiment in that: the connection member 6′ is a threaded bar and the bore 422′ formed in the back panel bottom board 42′ is a bore having internal threading, such as a second extruded threaded hole that is formed by recessing the back panel bottom board 42′ that has internal threading, which is formed by flanging and tapping the back panel bottom board 42′. The connection member 6′ has opposite ends that are provided with external threading respectively corresponding to the first extruded threaded hole 222′ and the second extruded threaded hole. The two ends of the connection member 6′ can be respectively screwed to the threads of the first extruded threaded hole 222′ and the second extruded threaded hole to fix the bezel 2′ to the back panel 4′. The connection member 6′ has an end face 62′ that forms a cruciform slit configuration 622′, allowing the connection member 6′ to be screwed with a Phillips screwdriver. Similarly, the end face 62′ of the connection member 6′ can alternatively form a straight slot to allow the connection member 6′ to be screwed with a flat-ended screwdriver. Further, as a further alternative of the instant embodiment, the threaded bar can be a bar having a cruciform cross-section, forming an abutment section in the middle thereof, so that the abutment section can abut against an end of the second extruded threaded hole in a screwing operation.

Further, the connection member 6 can mate the bore 222 of the bottom board 42 by means of riveting, of which the specific way of application is similar to what discussed above and repeated description will be omitted.

It is apparent that the connection member 6 can alternatively be a combination of mechanical parts, such as a bolt and a mating nut, of which the specific way of connection will not be redundantly described here.

In summary, the present invention provides a slim bezel backlight module of liquid crystal display device that securely fixes the bezel to the front plate of the back panel by forming an extruded threaded hole in an under surface of the front plate of the bezel and ensuring the flatness of the front surface of the bezel, so as to save a great amount of space and sites on the plastic frame and the back panel and avoid removal of material in a large area of the plastic frame for not interfering with the bumps of the bezel and the bumps of the back panel thereby guaranteeing the structural strength of the plastic frame and helping the sliming of the bezel for the backlight module.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A slim bezel backlight module of a liquid crystal display device, comprising a bezel, a back panel, a connection member, and a plastic frame arranged on the back panel, the bezel comprising a front plate that forms a displaying opening and a side plate extending downward from one end of the front plate, the back panel comprising a bottom board that is opposite to the front plate, the front plate of the bezel being recessed to form a first extruded threaded hole having internal threading, the bottom board of the back panel forming a bore corresponding to the first extruded threaded hole, the plastic frame forming a through hole corresponding to the bore, the connection member extending through the through hole and having two ends respectively mating and connecting the first extruded threaded hole of the front plate of the bezel and the bore of the bottom board of the back panel to thereby fix the bezel to the back panel.

2. The slim bezel backlight module of a liquid crystal display device as claimed in claim 1, wherein the connection member is a bolt and the bore is a through hole, the connection member extending through the bore and the through hole to have one of the ends thereof positioned against the bottom board of the back panel and the other one of the ends in threading engagement with the first extruded threaded hole.

3. The slim bezel backlight module of a liquid crystal display device as claimed in claim 1, wherein the bore of the bottom board of the back panel is a second extruded threaded hole formed by recessing the bottom board of the back panel and having internal threading, the connection member being a threaded bar having two ends forming external threads respectively corresponding to the first extruded threaded hole and the second extruded threaded hole, whereby the two ends of the connection member are respectively threadingly engageable with the first extruded threaded hole and the second extruded threaded hole.

4. The slim bezel backlight module of a liquid crystal display device as claimed in claim 3, wherein the connection member has an end face forming a cruciform or straight slit.

5. The slim bezel backlight module of a liquid crystal display device as claimed in claim 1, further comprising a light guide plate arranged on the back panel and an optic film arranged on the light guide plate.

6. The slim bezel backlight module of a liquid crystal display device as claimed in claim 1, wherein the back panel comprises a side board extending upward from an end of the bottom board, the plastic frame being arranged between the bezel and the back panel, the side plate of the bezel being located outside the side board of the back panel.
